(19) United States
(12) Patent Application Publication
(10) Pub. No.: US 2014/0152186 A1
(43) Pub. Date: Jun. 5, 2014

(54) LED BACKLIGHT DRIVING CIRCUIT, BACKLIGHT MODULE, AND LCD DEVICE

(71) Applicant: SHENZHEN CHINA STAR OPTOELECTRONICS TECHNOLOGY CO. LTD, Shenzhen (CN)

(72) Inventor: Hua Zhang, Shenzhen (CN)

(73) Assignee: SHENZHEN CHINA STAR OPTOELECTRONICS CO., LTD, Shenzhen (CN)

(21) Appl. No.: 13/807,702

(22) PCT Filed: Dec. 7, 2012
(86) PCT No.: PCT/CN12/86093

§ 371 Date: Dec. 28, 2012

(30) Foreign Application Priority Data
Nov. 30, 2012 (CN) 201210501274.X

(51) Int. Cl. H05B 33/08

(52) U.S. Cl. CPC H05B 33/089
USPC 315/193

(57) ABSTRACT

A light emitting diode (LED) backlight driving circuit includes a light bar and a power supply module that is coupled with the light bar. The light bar and the power supply module are connected by a flexible circuit board. The light bar is also connected with a measuring resistor in series. A test point is arranged at two ends of the measuring resistor.

### TECHNICAL FIELD

The present disclosure relates to the field of liquid crystal displays (LCDs), and more particularly to a light emitting diode (LED) backlight driving circuit, a backlight module, and an LCD device.

### BACKGROUND

With the popularization of light emitting diodes (LEDs), a typical liquid crystal display (LCD) device uses the LEDs as a backlight source. As shown in FIG. 1, a plurality of LEDs are connected in series to form a light bar. Then, one end of the light bar is connected to a power supply module, and the light bar is driven by the power supply module. The light bar and the power supply module are generally connected by a wire having a common material, which has advantage that measurement of current of an LED string is easy. However, connection costs are high if common material for the wire is used.

### SUMMARY

In view of the above-described problems, the aim of the present disclosure is to provide a light emitting diode (LED) backlight driving circuit, a backlight module, and a liquid crystal display (LCD) device with the advantages of being low in cost and convenient to measure current of an LED string.

The aim of the present disclosure is achieved by the following technical scheme.

An LED backlight driving circuit comprises a light bar and a power supply module that is coupled with the light bar. The light bar and the power supply module are connected by a flexible circuit board. The light bar is connected with a measuring resistor in series. A test point is arranged at two ends of the measuring resistor.

Furthermore, an area of the test point is greater than an area of a layout pad of the measuring resistor. The inventor finds that an area of a soldered dot formed by soldering material and a wire head soldered on the layout pad may exceed a range of the layout pad when the wire is soldered with the measuring resistor because the area of the layout pad of the measuring resistor is small. Thus, the soldered dot is easy to contact an adjacent layout pad or other components, causing a short circuit. In the present disclosure, the area of the test point is greater than the area of the layout pad. Thus, the area of the soldered dot is difficult to exceed the range of the test point, improving measuring reliability. In addition, the large test point reduces test difficulty and the difficulty of soldering the wire, operation is easy.

Furthermore, a lead wire is arranged at two ends of the measuring resistor. The test point is arranged at an end of the lead wire away from the measuring resistor. In the technical scheme, the lead wire is used as transition. Thus, the test point is extended to a wide circuit board region beneficial to test when a surrounding space of the measuring resistor is narrow and disadvantageous to test, facilitating test and improving test reliability.

Furthermore, spacing between the test points is greater than spacing between the layout pads at two ends of the measuring resistor. A thin wire is soldered on the test point when testing a current, the spacing between the test points is increased so that two adjacent thin wires are difficult to contact, further avoiding generating a short circuit between the thin wires.

Furthermore, the measuring resistor is connected to an output end of the light bar in series. A dimming controllable switch is connected in series between the measuring resistor and a grounding end of the LED backlight driving circuit. A control end of the dimming controllable switch is connected with a constant current driving chip. This is an LED backlight driving, circuit having function of controlling a constant current.

Furthermore, a sampling resistor is connected in series between the dimming controllable switch and the grounding end of the LED backlight driving circuit. A voltage difference between two ends of the sampling resistor is fed back to the constant current driving chip. This is an LED backlight driving circuit having function of feedback constant current control.

Furthermore, the constant current driving chip comprises a comparator. The voltage difference between two ends of the sampling resistor is fed back to an inverting input of the comparator. An output of the comparator is coupled to the control end of the dimming controllable switch. This is a specific circuit structure of the constant current driving chip.

Furthermore, the measuring resistor is connected to an output end of the light bar in series. A dimming controllable switch and a sampling resistor are successively connected in series between the measuring resistor and a grounding end of the LED backlight driving circuit. A control end of the dimming controllable switch is connected with a constant current driving chip. The constant current driving chip comprises a comparator. A voltage difference between two ends of the sampling resistor is fed back to an inverting input of the comparator An output end of the comparator is coupled to the control end of the dimming controllable switch. A lead wire is arranged at two ends of the measuring resistor. The test point is arranged at an end of the lead wire away from the measuring resistor. An area of the test point is greater than an area of a layout pad of the measuring resistor. Spacing between the test points is greater than spacing between the layout pads at two ends of the measuring resistor. This is a specific LED backlight driver circuit.

A backlight module comprises the LED backlight driving circuit mentioned above.

An LCD device comprises the backlight module mentioned above.

In the present disclosure, the flexible circuit board (FFC) is used to replace the wire with the common material to be connected, reducing the cost. When layout is converted, one measuring resistor is put into the circuit of each LED string. A multimeter is used to measure the voltage value on the measuring resistor. The current value of the LED light bar is computed by an Ohm's law. Because the space of the circuit board is small, the multimeter is easy to generate poor contact when measuring. In addition, the waveform of LED current in a 3D mode is a rectangular wave. The duty may not be measured by the multimeter. The measuring resistor needs to be taken off by an electric soldering iron. Then, a thin wire is soldered on two ends of the layout pad of the measuring resistor. A check meter of current of an oscillograph is used to measure the waveform of the LED current. The distance between the layout pads of the measuring resistor is close. Condition of the short circuit is easy to occur in practical soldering so that operation is complicated and time is easy to waste. In the present disclosure, because the test point is added at two ends of the measuring resistor and the area of the test point is greater than the area of the layout pad of on two ends of the measuring resistor, a probe of a measuring tool, such as multimeter, may be in reliable contact with the test point and is prevented from contacting other components, which enhances measuring reliability. When the oscillograph is used to measure, the thin wire may be directly soldered to the test points. The layout pad of the measuring resistor is not used. The wire is difficult to short-circuit, with convenience in operation and high reliability.

### BRIEF DESCRIPTION OF FIGURES

FIG. 1 is a schematic diagram of driving a light emitting diode (LED) in the prior art; and

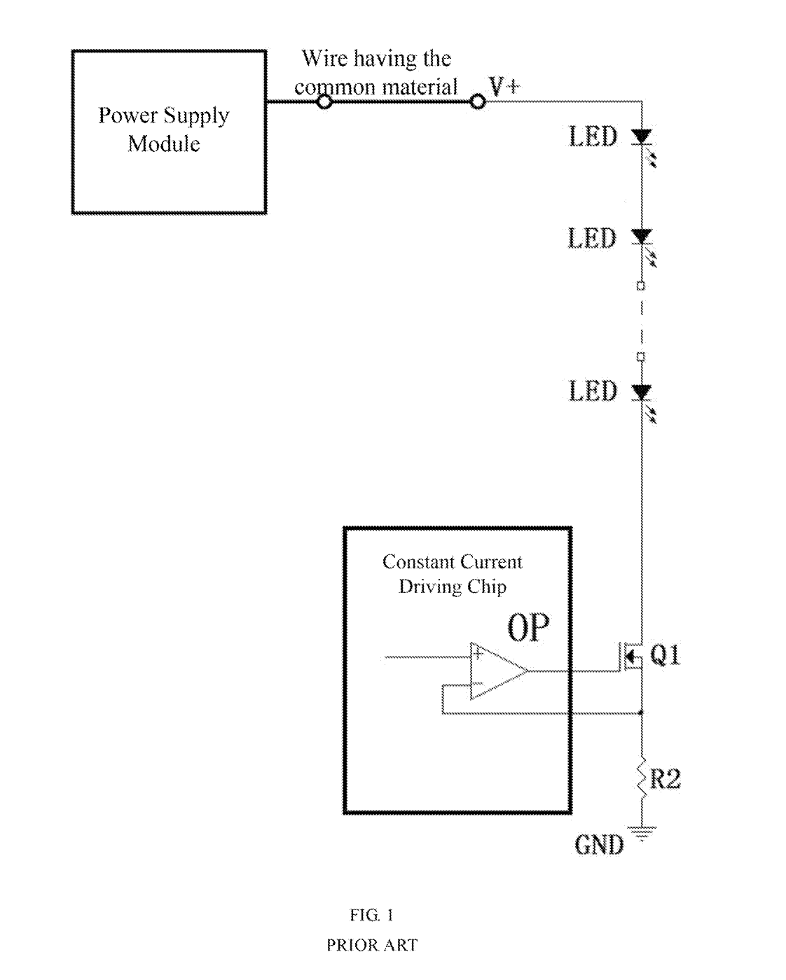

FIG. 2 is a schematic diagram of an example of the present disclosure.

### DETAILED DESCRIPTION

The present disclosure discloses a liquid crystal display (LCD) device. The LCD device comprises a backlight module. The backlight module comprises a light emitting diode (LED) backlight driving circuit. The LED backlight driving circuit comprises a light bar and a measuring resistor that is connected with the light bar in series. Two ends of the measuring resistor are configured with a test point. An area of the test point is greater than an area of a layout pad of the measuring resistor.

In the present disclosure, because the test point is added at two ends of the measuring resistor and the area of the test point is greater than the area of the layout pad of on two ends of the measuring resistor, a probe of a measuring tool, such as multimeter, may be in reliable contact with the test point and is prevented from contacting other components, which enhances measuring reliability. The inventor finds that an area of a soldered dot formed by soldering material and a wire head soldered on the layout pad may exceed a range of the layout pad when the wire is soldered with the measuring resistor because the area of the layout pad of the measuring resistor is small. Thus, the soldered dot is easy to contact an adjacent layout pad or other components, causing a short circuit. In the present disclosure, the area of the test point is greater than the area of the layout pad. Thus, the area of the soldered dot is difficult to exceed the range of the test point, improving measuring reliability. In addition, the large test point reduces test difficulty and the difficulty of soldering the wire, operation is easy.

The present disclosure is further described in detail in accordance with the figures and the exemplary examples.

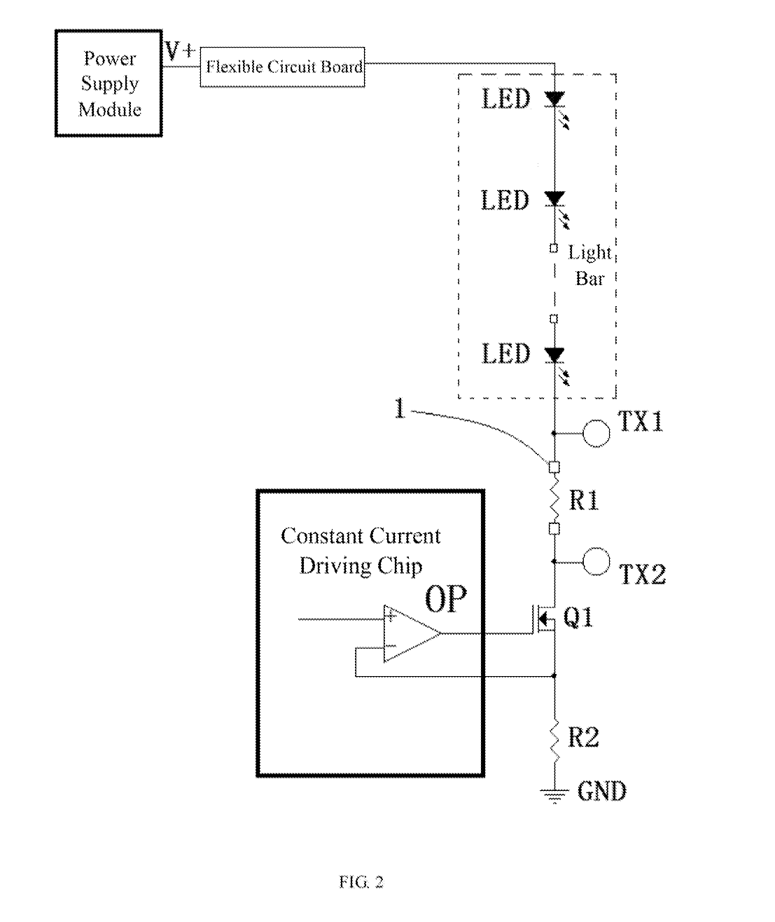

As shown in FIG. 2, an LED backlight driving circuit is disclosed in the example. The LED backlight driving circuit comprises a light bar and a measuring resistor (R1) that is connected with the light bar in series. The measuring resistor (R1) is connected to an output end of the light bar in series. A dimming controllable switch (Q1) and a sampling resistor (R2) are successively connected in series between the measuring resistor (R1) and a grounding end of the LED backlight driving circuit. A control end of the dimming controllable switch (Q1) is connected with a constant current driving chip. The constant current driving chip comprises a comparator (OP). A voltage difference between two ends of the sampling resistor (R2) is fed back to an inverting input of the comparator (OP). An output of the comparator (OP) is coupled to the control end of the dimming controllable switch (Q1). Two ends of the measuring resistor (R1) are configured with a lead wire outwards extending, respectively. An end of the lead wire away from the measuring resistor (R1) is configured with a test point (TX1, TX2). An area of the test point (TX1, TX2) is greater than an area of a layout pad 1 of the measuring resistor. Spacing between the two test points (TX1, TX2) is greater than spacing between two layout pads which is respectively on two ends of the measuring resistor (R1).

In the example, the lead wire is used as transition. Thus, the test point is extended to a wide circuit board region beneficial to test when a surrounding space of the measuring resistor is narrow and disadvantageous to test, facilitating test and improving test reliability. In addition, a thin wire is soldered on the test point when testing a current, the spacing between the test points is increased so that two adjacent thin wires are difficult to contact, further avoiding generating a short circuit between the thin wires. Optionally, in the present disclosure, the lead wire may not be used, and the test points are directly arranged on two ends of the measuring resistor.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A light emitting, diode (LED) backlight driving circuit comprising
a light bar; and
a power supply module coupled with the light bar;
wherein the light bar and the power supply module are connected by a flexible circuit board, the light bar is connected with a measuring resistor in series, a test point is arranged at two ends of the measuring resistor.

2. The light emitting diode (LED) backlight driving circuit of claim 1, wherein an area of the test point is greater than area of a layout pad of the measuring resistor.

3. The light emitting diode (LED) backlight driving circuit of claim 1, wherein a lead wire is arranged at two ends of the measuring resistor, the test point is arranged at an end of the lead wire away from the measuring resistor.

4. The light emitting diode (LED) backlight driving circuit of claim 3, wherein spacing between the test points is greater than spacing between the layout pads at two ends of the measuring resistor.

5. The light emitting diode (LED) backlight driving circuit of claim 1, wherein the measuring resistor is connected to an output end of the light bar in series, a dimming controllable switch is connected in series between the measuring resistor and a grounding end of the LED backlight driving circuit, a control end of the dimming controllable switch is connected with a constant current driving chip.

6. The light emitting diode (LED) backlight driving circuit of claim 5, wherein a sampling resistor is connected in series between the dimming controllable switch and the grounding end of the LED backlight driving circuit, a voltage difference between two ends of the sampling resistor is fed back to the constant current driving chip.

7. The light emitting diode (LED) backlight driving circuit of claim 6, wherein the constant current driving chip comprises a comparator, the voltage difference between two ends of the sampling resistor is fed back to an inverting input of the comparator, an output of the comparator is coupled to the control end of the dimming controllable switch.

8. The light emitting diode (LED) backlight driving circuit of claim 1, wherein the measuring resistor is connected to an output end of the light bar in series, a dimming controllable switch and a sampling resistor are successively connected in series between the measuring resistor and a grounding end of the LED backlight driving circuit, a control end of the dimming controllable switch is connected with a constant current driving chip; wherein the constant current driving chip comprises a comparator, a voltage difference between two ends of the sampling resistor is fed back to an inverting input of the comparator, an output of the comparator is coupled to the control end of the dimming controllable switch; wherein a lead wire is arranged at two ends of the measuring resistor, the test point is arranged at an end of the lead wire away from the measuring resistor, an area of the test point is greater than an area of a layout pad of the measuring resistor, a spacing between the test points is greater than a spacing between the layout pads at two ends of the measuring resistor.

9. A backlight module, comprising:
a light emitting diode (LED) backlight driving circuit;
wherein the LED backlight driving, circuit comprises a light bar and a power supply module that is coupled with the light bar, the light bar and the power supply module are connected by a flexible circuit board, wherein the light bar is connected with a measuring resistor in series, a test point is arranged at two ends of the measuring resistor.

10. The backlight module of claim 9, wherein an area of the test point is greater than an area of a layout pad of the measuring resistor.

11. The backlight module of claim 9, wherein a lead wire is arranged at two ends of the measuring resistor, the test point is arranged at an end of the lead wire away from the measuring resistor.

12. The backlight module of claim 11, wherein spacing between the test points is greater than spacing between the layout pads at two ends of the measuring resistor.

13. The backlight module of claim 9, wherein the measuring resistor is connected to an output end of the light bar in series, a dimming controllable switch is connected in series between the measuring resistor and a grounding end of the light emitting, diode (LED) backlight driving circuit, a control end of the dimming controllable switch is connected with a constant current driving chip.

14. The backlight module of claim 13, wherein a sampling resistor is connected in series between the dimming controllable switch and the grounding end of the LED backlight driving circuit, a voltage difference between two ends of the sampling resistor is fed back to the constant current driving chip.

15. The backlight module of claim 14, wherein the constant current driving chip comprises a comparator, the voltage difference between two ends of the sampling resistor is fed back to an inverting input of the comparator, an output of the comparator is coupled to the control end of the dimming controllable switch;

16. The backlight module of claim 9, wherein the measuring resistor is connected to an output end of the light bar in series, a dimming controllable switch and a sampling resistor are successively connected in series between the measuring resistor and a grounding end of the light emitting diode (LED) backlight driving circuit; wherein a control end of the dimming controllable switch is connected with a constant current driving chip, the constant current driving chip comprises a comparator, a voltage difference between two ends of the sampling resistor is fed back to an inverting input of the comparator, an output of the comparator is coupled to the control end of the dimming controllable switch; wherein a lead wire is arranged at two ends of the measuring resistor, the test point is arranged on an end of the lead wires away from the measuring resistor, an area of the test point is greater than an area of a layout pad of the measuring resistor, a spacing between the test points is greater than a spacing between the layout pads at two ends of the measuring resistor.

17. A light crystal display (LCD) device, comprising:
a backlight module of claim 9.
